(19) United States
(12) Patent Application Publication
(10) Pub. No.: US 2017/0254948 A1
(43) Pub. Date: Sep. 7, 2017

(54) GLASS LIGHT GUIDE PLATE, MOLD, AND METHOD OF MANUFACTURING SAME

(71) Applicant: HON HAI PRECISION INDUSTRY CO., LTD., New Taipei (TW)

(72) Inventors: FENG-YUEN DAI, Tu-Cheng (TW); CHAU-JIN HU, Tu-Cheng (TW); CHIN-LUNG CHIU, New Taipei (TW); HSIN-HUA CHANG, Tu-Cheng (TW); YUNG-LUN HUANG, Tu-Cheng (TW); YAO-CHIEN CHUANG, New Taipei (TW); CHUNG-PEI WANG, New Taipei (TW)

(21) Appl. No.: 15/230,872

(22) Filed: Aug. 8, 2016

(30) Foreign Application Priority Data
Mar. 1, 2016 (CN) 201610114182.4

(51) Int. Cl. F21V 8/00; C03B 11/00; C03B 11/07

(52) U.S. Cl. CPC G02B 6/0065; C03B 11/07; C03B 11/005; G02B 6/0036

(57) ABSTRACT

A mold which is made of a porous heat-resistant material comprises a first surface and a second surface opposite to the first surface. A plurality of light guide spots are formed on the first surface. The light guide spots are light guide spots. The first surface is a smooth polished surface, the mold enables direct manufacture of light guide plates for less heat expended.

### FIELD

The present disclosure relates to light guide plates, particularly to a mold, a method of manufacturing a glass light guide plate, and the light guide plate manufactured by the mold.

### BACKGROUND

Traditional light guide plate is made of polymethylmethacrylate (PMMA) and other materials. Yellowing and color bias will appear in the light absorption process of PMMA, which affects the energy-saving and durability of the light guide plate.

### BRIEF DESCRIPTION OF THE DRAWINGS

Implementations of the present technology will now be described, by way of example only, with reference to the attached figures, wherein:

FIG. 1 is a schematic view of a substrate of a first embodiment of the present disclosure.

FIG. 2 is a schematic view of a mold that is manufactured from the substrate of FIG. 1.

FIG. 3 is a top plan view of a first surface of the mold of FIG. 2.

FIG. 4 is a schematic view of a glass substrate placed on the mold in a method of manufacturing a glass light guide plate.

FIG. 5 is a schematic view of a light guide plate using the manufacturing method of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

One definition that applies throughout this disclosure will now be presented.

The term “comprising,” when utilized, means “including, but not necessarily limited to”; it specifically indicates open-ended inclusion or membership in the so-described combination, group, series and the like.

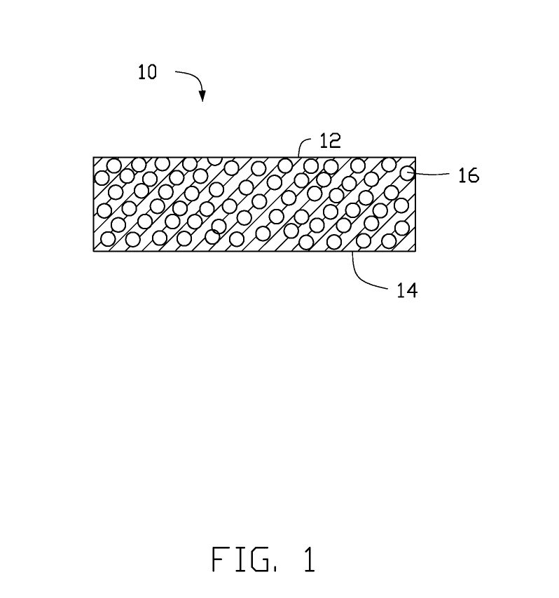

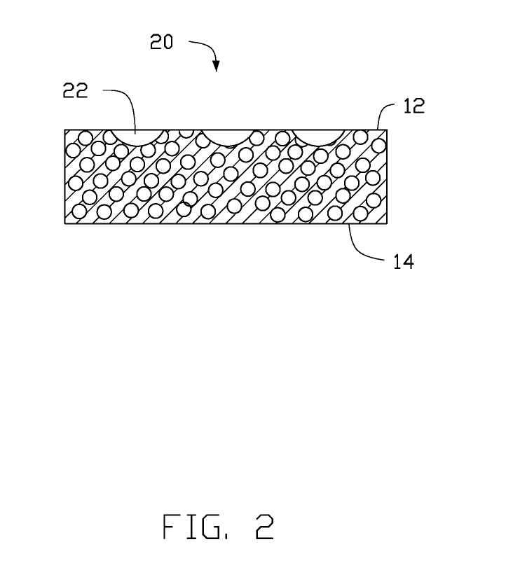

FIG. 1 and FIG. 2 illustrate a manufacturing method for a mold for manufacturing a light guide plate.

FIG. 1 illustrates a substrate 10. In the illustrated embodiment, the substrate 10 is a cubic. The substrate 10 includes a first surface 12 and a second surface 14. In other embodiments, the substrate 10 can be any other shape, provided that the substrate 10 has two parallel and opposite smooth surfaces.

The substrate 10 is made of porous heat-resistant material. The porous heat-resistant material is selected from one or several combinations of Hexagonal Boron Nitride (HBN), silica (SiO2) and alumina (Al2O3), and hexagonal carbon (C). The porous heat-resistant material should have high mechanical strength. The density (D) of the porous heat-resistant material range is from about 2.4 grams per cubic centimeter (g/cm3) to about 6.4 grams per cubic centimeter (g/cm3). The porous heat-resistant material should withstand temperatures of between about 500° C. and about 1500° C. The porous heat-resistant material should maintain its shape at these temperatures for a long time. Holes 16 are formed in the porous heat-resistant material, the holes 16 are distributed evenly and are interconnected. The size of aperture (d) of the holes 16 is from about 0.1 nanometers (nm) to about 2.1 microns (μm). Thus, the whole substrate 10 is permeable to air.

FIG. 2 illustrates a mold 20. The mold 20 is manufactured using the substrate 10.

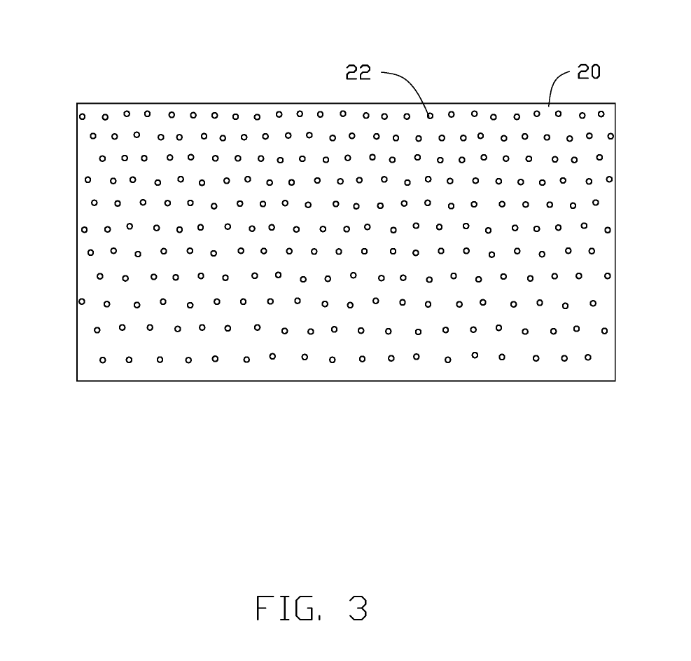

In detail, the substrate 10 is processed. Light guide spots 22 are formed in the first surface 12. FIG. 3 illustrates that the light guide spots 22 are distributed on the first surface 12. A surface processing method can be any of mechanical drilling, laser drilling, chemical etching, physical vapor deposition (PVD), and chemical vapor deposition (CVD).

Each light guide spot 22 has a same shape and size. In the illustrated embodiment, the plurality of light guide spots 22 is spread on the first surface 12 according to the desired optical design. The light guide spots 22 are substantially hemispherical recesses. Each of the plurality of light guide spots 22 have a diameter ranging from 30 microns to 400 microns in a direction parallel to first surface 12. The plurality of light guide spots 22 have a depth ranging from 30 microns to 400 microns in a direction perpendicular to the first surface 12.

Due to a roughness requirement of the light guide plate surface, the mold 20 is polished to obtain a smooth first surface 12 (molding surface) after the formation of light guide spots 22.

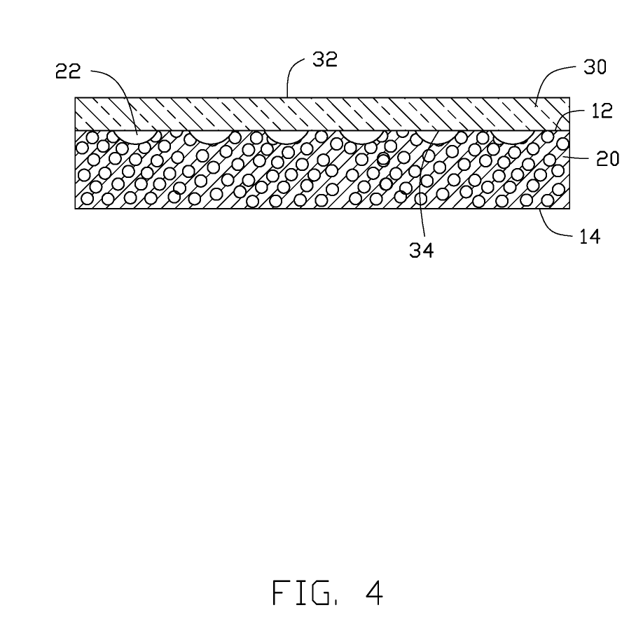

FIG. 4 illustrates the mold 20 and a glass substrate 30. The glass substrate 30 is cubic. The shape and size of glass substrate 30 are substantially equal to those of the mold 20. However, the glass substrate 30 can have any thickness. In the illustrated embodiment, the thickness of the glass substrate 30 is far smaller than the thickness of the mold 20. The glass substrate 30 includes an upper surface 32 and a lower surface 34. The upper surface of 32 and the lower surface 34 are on opposite sides of the glass substrate 30.

The glass substrate 30 is manufactured into a light guide plate 100 by the following steps. The mold 20 is heated to the glass transition temperature Tg of the glass substrate 30 (temperature of transforming polymer from high elastic state into glass state). The glass transition temperature Tg of the glass substrate 30 is less than about 1500° C. The mold 20 is kept at this temperature, and the lower surface 34 of the glass substrate 30 is placed on the first surface 12. During the molding operation, air is exhausted from the mold 20 to generate suction (negative pressure) and the glass substrate 30 is absorbed onto the first surface 12. The glass substrate 30 is softened by heat conduction, the softened glass filling the plurality of light guide spots 22 on the first surface 12. Heating is removed from the mold 20, the temperature of the mold 20 is reduced below the glass transition temperature Tg and gradually cooled to room temperature. The mold 20 is removed, and the glass light guide plate 100 is thereby obtained.

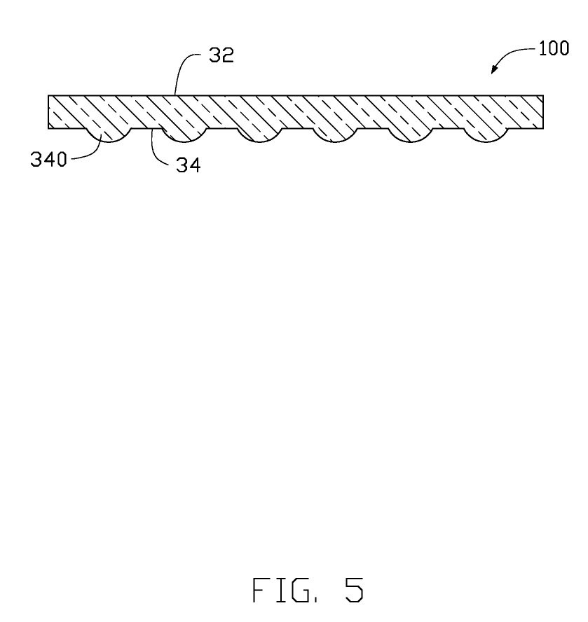

FIG. 5 illustrates the glass light guide plate 100. The glass light guide plate 100 includes an upper surface 32 and a lower surface 34. The upper surface 32 and the lower surface 34 are located at the opposite sides of the glass light guide plate 100. A plurality of protrusions 340 are formed on the lower surface 34. The plurality of protrusions 340 are spread on the lower surface according to the desired optical design. The number and positions of the plurality of protrusions 340 correspond to the number and positions of the light guide spots 22. Each of the plurality of protrusions 340 is substantially the same size and shape. The protrusions 340 are arc-shaped protrusions. The plurality of protrusions 340 have a diameter range from 30 microns to 400 microns in a direction parallel to the lower surface 34. The depth of the protrusions 340 ranges from 30 microns to 400 microns in a direction perpendicular to the lower surface 34.

The mold 20 is made of a porous heat-resistant material, the porosity contributing to the generation of suction during molding of the plate 100 (air is removed through the pores), thereby the softened glass material molding is absorbed on the forming surface after heating to the glass transition temperature.

The glass light guide plate 100 can be polished to form a smooth surface depending on the circumstances after molding.

The plurality of light guides 22 can be selected from different desired optical designs based on different refractive indexes of the glass substrate 30.

The glass substrate 30 can be post-processed by physical vapor deposition for example, or chemical vapor deposition, or surface treatment.

The manufacturing method of the glass light guide plate of the present disclosure provides a glass molding technology, microstructures of light guide plate being directly formed on the glass surface. The glass light guide plate 100 has a better light guide plate penetration than traditional PMMA, and is more durable and energy-efficient. Yellowing and color biasing in the glass production process of the light guide plate are much reduced.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A mold made of a porous heat-resistant material, the mold comprising:
a first surface and a second surface opposite to the first surface, wherein the first surface is a smooth polished surface;
a plurality of light guide spots formed on the first surface, wherein the light guide spots are substantially hemispherical recesses.

2. The mold of claim 1, wherein each of the light guide spots has a diameter in a range of 30 microns to 400 microns and a depth in a range of about 3 microns to about 40 microns.

3. The mold of claim 1, wherein the porous heat-resistant material is selected from one or more of hexagonal boron nitride (HBN), silicon oxide (SiO2), alumina (Al2O3), and hexagonal layers of carbon (C).

4. The mold of claim 1, wherein the porous heat-resistant material is capable of withstanding temperatures of about 500° C. to about 1500° C.

5. The mold of claim 1, wherein the porous heat-resistant material is made by holes formed in the mold, the holes are distributed evenly and mutually connected, a size of aperture (d) of the holes is from about 0.1 nanometers (nm) to about 2.1 microns (μm).

6. A method of manufacturing a glass light guide plate, comprising:
providing a mold and a glass substrate, the mold being made of a porous heat-resistant material and comprising a first surface and a second surface opposite to the first surface, the first surface being smooth and polished;
forming a plurality of light guide spots in the mold, wherein the light guide spots are substantially hemispherical recesses, the glass substrate comprises an upper surface and a lower surface opposite to the upper surface, a glass transition temperature of the glass substrate is less than a heat resistance temperature of the mold;
heating the mold to the glass transition temperature of the glass substrate;
maintaining the temperature of the mold at the glass transition temperature, placing the lower surface of the glass substrate on the first surface of the mold;
exhausting air from the mold to adhere the glass substrate on the first surface; and
separating the mold from the glass substrate, whereby the glass substrate forms the glass light guide, the light guide plate comprising a plurality of hemispherical protrusions corresponding to the hemispherical recesses.

7. The method of claim 6, wherein during the step of placing the lower surface of the glass substrate on the first surface of the mold, the glass substrate is softened and fills the plurality of light guide spots to form the substantially hemispherical protrusions.

8. The method of claim 6, wherein the porous heat-resistant material is capable of withstanding temperatures of about 500° C. to about 1500° C.

9. The method of claim 6, wherein the porous heat-resistant material is made by forming holes in the mold, the holes are distributed evenly and mutually connected, a size of aperture (d) of the holes are from about 0.1 nanometers (nm) to about 2.1 microns (μm).

10. A guide plate glass made by the method of claim 6, wherein the glass light guide plate includes an upper surface and a lower surface, the upper surface is opposite to the lower surface, spherical protrusions are formed on the lower surface.
